(19) United States
(12) Patent Application Publication
(10) Pub. No.: US 2025/0065753 A1
(43) Pub. Date: Feb. 27, 2025

(54) EV ARTIFICIAL INTELLIGENCE BASED CHARGING SYSTEM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/815,782

(22) Filed: Aug. 26, 2024

Related U.S. Application Data
(60) Provisional application No. 63/534,394, filed on Aug. 24, 2023.

(51) Int. Cl. B60L 53/64

(52) U.S. Cl. CPC B60L 53/64

(57) ABSTRACT

One or more examples provide an electric vehicle or a device for use with an electric vehicle, including an electric vehicle charging system and method. At least one example provides an electric vehicle artificial intelligence based charging system.

### CROSS-REFERENCE TO RELATED APPLICATION

This Non-Provisional patent application claims the benefit of the filing date of U.S. Provisional Patent Application Ser. No. 63/534,394, filed Aug. 24, 2023, which is incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

Problems exist when using a charging system to charge all different types of electric vehicles. There is a need for optimizing a charging event for each specific electric vehicle.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device. The electric vehicle charging system uses artificial intelligence for optimized charging specific to the electric vehicle.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices, including an electric vehicle artificial intelligence based charging system.

FIG. 1 is a diagram generally illustrating an artificial intelligence based charging system, according to examples of the present disclosure.

FIG. 2 is a block diagram illustrating an artificial intelligence based charging system, according to examples of the present disclosure.

FIG. 3 is a block diagram illustrating a charging station having an ai engine, according to examples of the present disclosure.

FIG. 4 is a block diagram illustrating an artificial intelligence based charging station, according to examples of the present disclosure.

FIG. 5 is a block diagram generally illustrating an ai engine for use in a charging station, according to examples of the present disclosure.

FIG. 6 is a block diagram illustrating a method for charging a vehicle using artificial intelligence, according to examples of the present disclosure.

FIG. 7 is a block diagram illustrating a method for charging a vehicle using artificial intelligence, according to examples of the present disclosure.

FIG. 8 is a diagram illustrating a charging system including using artificial intelligence components for determining an electric vehicle optimized charging configuration, according to examples of the present disclosure.

FIG. 9 is a diagram illustrating artificial intelligence data components for use in a charging system, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, snowmobiles, electric watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

Electric Vehicle Charging System with Artificial Intelligence

The present disclosure provides an electric vehicle charging system that utilizes artificial intelligence for optimal charging of an electric vehicle. The charging system optimizes both charging load and charging costs. Additionally, the charging system optimizes charging specific to the electric vehicle requesting a charge.

Operation of the electric vehicle charging system may be done either local to the charging station or charging vehicle or remotely via a computer, ev control system, charging station control system, or a user control application located on a smart device (e.g., via a phone).

An electric vehicle artificial intelligence based charging system for optimized charging can include a combination of one or more of the following features:

Charging Station with AI. Charging station “learns” specifics associated with a specific vehicle due to previous charging of the vehicle.

Smart Charging Station. Charging station could be linked to the Internet or a private network. Once a vehicle to be charged is identified, the charging station can immediately look up optimal charging for that vehicle and apply it to the vehicle. The charging station can also learn from charging vehicles with similar battery systems.

The charging station could apply AI in other ways. For example, based on communicated vehicle type/charging configuration the charging station can link up with the vehicle. If charge at a different location/charging at a first location or charging station. Could use AI for for OTHER/EXTERNAL/AI data and apply it to the charging event to optimize charging of the vehicle at that time. For example, could retrieve relevant weather data, and based on the data could change one or more charging elements. If cold, could cause the charging station to turn on plug heater or battery pack heaters.

EXAMPLE 1. Home charging system. Automatically charges your car hands-free; wirelessly communicates with EV when you pull into garage; determines charge level of EV battery; based on duration of available charge time, the charging station automatically charges the EV battery using the voltage level that minimizes battery degradation; in one case, a user may designate the available charging duration (e.g., enter next time car will be used); in one case, the charging station may estimate the available charging duration using AI (e.g., based on time of year, day of week, time of day, amount battery is discharged after each use).

EXAMPLE 2. Home charging system. Home chargers could use AI to determine EV owners driving habits. They could charge to optimize utility energy rates and the least amount of battery degradation. AI could also determine household energy usage based on how much time is available to charge the vehicle, the charging station could charge the EV at a time that optimizes the combination of interference with household loads, utility rates, and battery degradation. EV owner wouldn't have to do a single thing . . . except enter the next time he/she plans to drive the vehicle. If the driver does not enter a time, the charging station uses the AI estimated charging time which is available.

EXAMPLE 3. Charging Station includes an AI Engine in communication with the electric vehicle requesting a charge and an AI network. The AI network may include the Internet. The Charging Station may also include a smart controller that communicates with the AI Engine. The AI Engine is capable of communicating with a remote database or remote charging stations via the AI Network.

EXAMPLE 4. In one mode of operation, the AI Charging Station establishes a communication link with the vehicle requesting a charge (e.g., a wireless link, bluetooth link, Bluetooth Low Energy, or via another communication protocol). The AI Engine is used to determine optimal charging configuration (OCC) specific to the vehicle requesting a charge using AI data. The port configuration for the vehicle requesting a charge is determined. The charging station is automatically coupled to the vehicle, The vehicle is then charged using the optimal charging configuration determined using the AI data.

EXAMPLE 5. In one example, AI Data Components used to determine a vehicles optimal charging configuration include one or more of the following: EV type/configuration/battery setup (could be supplied by vehicle manufacturer and associated with vehicle VIN number); Charging Station Location Data Components (e.g., current weather, etc.); Specific user charging preferences (e.g., desired charging speed, optimal rate, maximize charging cost, could be preset configuration set by user); Optimal charging configuration based on charging history (either logged by vehicle or available via AI data from remote/other charging locations), may be combined with vehicle performance/battery performance as a result of charging history; Utility AI data components specific to charging station location (e.g., energy rates that may vary based on type of charge, rate of charge, time of day, load balancing, etc.); Home or Facility AI Components (e.g., charging rate or load balancing based on charging as part of a home charging system or charging facility having multiple vehicles charged at a given time; and Other AI data.

AI Engine. AI Engine can operate as an AI Data Aggregator of data from multiple AI sources, and use that data to determine the Optimal Charging Configuration for a specific vehicle. Optimal Charging Configuration can be determined using user preferences and different weighting of AI Data. Users could be presented with OCC options based on desired speed of charge, cost of charge etc., with optimal charging being selected based on a user preference input.

In one or more examples, the electric vehicle requesting a charge includes a charging history database, including what charging configurations work better for vehicle performance, that can be communicated with the charging station as part of the AI data aggregated by the charging station AI Engine.

AI Charging System provides for hands-free optimal charging of an electric vehicle. In one example, the electric vehicle can be charged by simply using voice commands.

One or more examples and features of the charging system are detailed herein and illustrated in the Figures.

The present disclosure provides an electric vehicle charging system that utilizes artificial intelligence for optimal charging of an electric vehicle. The charging system optimizes both charging load and charging costs. Additionally, the charging system optimizes charging specific to the electric vehicle requesting a charge.

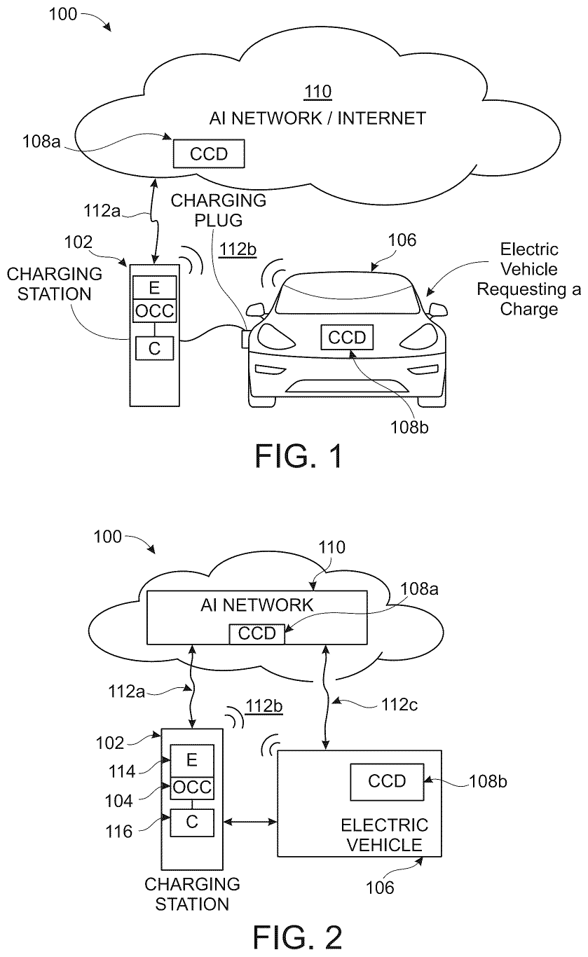

FIG. 1 is a diagram generally illustrating an example charging system 100. Charging system 100 is an artificial intelligence based charging system. The charging system 100 uses artificial intelligence to optimize charging of an electric vehicle. The charging system 100 uses artificial intelligence to optimize charging specific to the electric vehicle requesting a charge.

In one example, charging system 100 includes a charging station 102. The charging station 102 includes an optimized charging configuration (OCC) 104. The optimized charging configuration 104 is specific to an electric vehicle 106 requesting a charge. The charging station 102 charges the electric vehicle 106 according to the optimized charging configuration 104, maximizing charging of the electric vehicle 106.

The charging station 102 includes an ai engine 114. The ai engine 114 aids in determining the optimized charging configuration 104. In one example, the ai engine 114 requests the optimized charging configuration 104 from an ai network or from the electric vehicle requesting a charge. In another example, the ai engine 114 requests charging configuration data from an external source. The ai engine 114 uses the charging configuration data to determine the optimized charging configuration 104. In one example, the ai engine 114 includes an optimized charging configuration model. The model can be user defined or defined by the ai engine 114. The ai engine 114 applies the charging configuration data to the optimized charging configuration model to determine the optimized charging configuration for the electric vehicle requesting a charge.

In one example, electric vehicle 106 requesting a charge identifies itself to the charging station 102 (e.g., by vehicle identification number or other unique identifier). In response, charging station 102 uses ai engine 114 to request an optimized charging configuration 104 specific to the electric vehicle 106. The ai engine 114 requests the optimized charging configuration 104 from an external network (e.g., such as a private or artificial intelligence network), from the electric vehicle 106 itself (e.g., optimized charging configuration specific to the electric vehicle 106 is stored in memory on the electric vehicle 106), or requests it from an ai history memory storage location on the charging station 102.

In other examples, charging configuration data specific to the electric vehicle 106 requesting a charge is downloaded to the charging station 102 by the ai engine 114 and used to determine the optimized charging configuration 104 specific to the electric vehicle 106. The ai engine 114 receives charging configuration data for charging the electric vehicle 106. The charging configuration data is received from one or more sources. In one example, the charging configuration data 108a includes artificial intelligence data, and the sources include one or more artificial intelligence networks 110. The charging station 102 can also receive charging configuration data 108b from the electric vehicle 106 requesting a charge. The charging station 102 uses charging configuration data 108a,b to determine an optimized charging configuration 104 for the electric vehicle 106. During a charging operation, the charging station 102 applies the optimized charging configuration 104 to the charging operation, maximizing charging of the electric vehicle 106.

FIG. 2 is a block diagram illustrating example charging system 100. The charging station 102 is in communication with artificial intelligence network 110, indicated at 112a. The charging station 102 is in communication with electric vehicle 106 requesting a charge, indicated at 112b. Electric vehicle 106 can also be in communication with artificial intelligence network 110, indicated at 112c.

Communication links 112a, 112b, and 112c can be wireless or wire communication links, or a combination of wired and wireless communication links.

In one example, the charging configuration data 108 is provided to an ai engine 114. The ai engine 114 determines the optimized charging configuration 104 specific to the vehicle requesting a charge. The optimal charging configuration 104 is provided to the charging station controller 116. The charging station controller 116 controls charging of the electric vehicle 106, including charging the electric vehicle 106 according to the optimal charging configuration 104. The ai engine 114 can be part of the charging station controller 116 or located separate from the charging control station controller 116. In one example, the ai engine 114 is configurable using a user interface, such as a cellphone, graphical user interface, computer, or an electric vehicle interface.

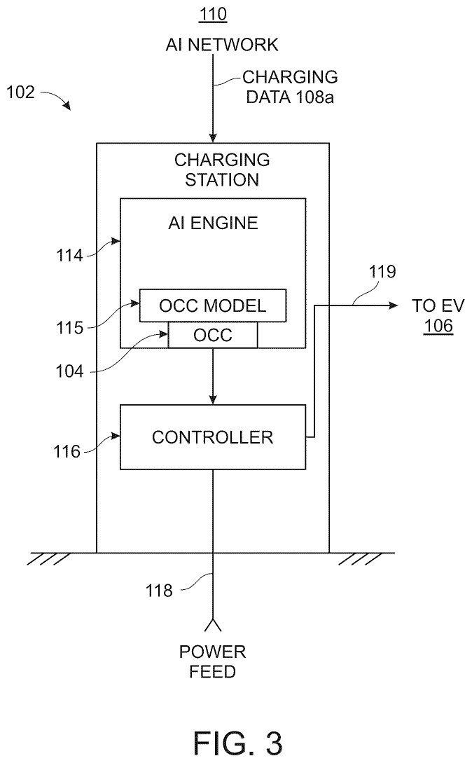

FIG. 3 is a block diagram illustrating one close-up example of a charging station, illustrated as charging station 102. The charging station 102 includes ai engine 114 and charging station controller 116. In this example, optimized charging configuration 104 is part of ai engine 114.

At 118, an input power feed 118 is fed into charging station 102. Charging station 102 includes a charging power output 119. Controller 116 manages the charging power output 119 to electric vehicle 106 according to a determined optimized charging configuration 104.

In one example, electric vehicle 106 requesting a charge identifies itself to the charging station 102 (e.g., by vehicle identification number or other unique identifier). In response, charging station 102 determines an optimized charging configuration 104 specific to the electric vehicle 106. Ai network 110 is accessed by ai engine 114 for charging data 108a specific to the electric vehicle 106. The charging system 114 receives the charging data 108a and determines the optimized charging configuration 104 specific to electric vehicle 106. In one example, the charging system 114 determines the optimized charging configuration 104 specific to the electric vehicle 106 using a predetermined charging configuration model 115 defined by the user requesting a charge. The controller 116 uses the optimized charging configuration 104 to control the charging parameters of the charging feed to the electric vehicle 106.

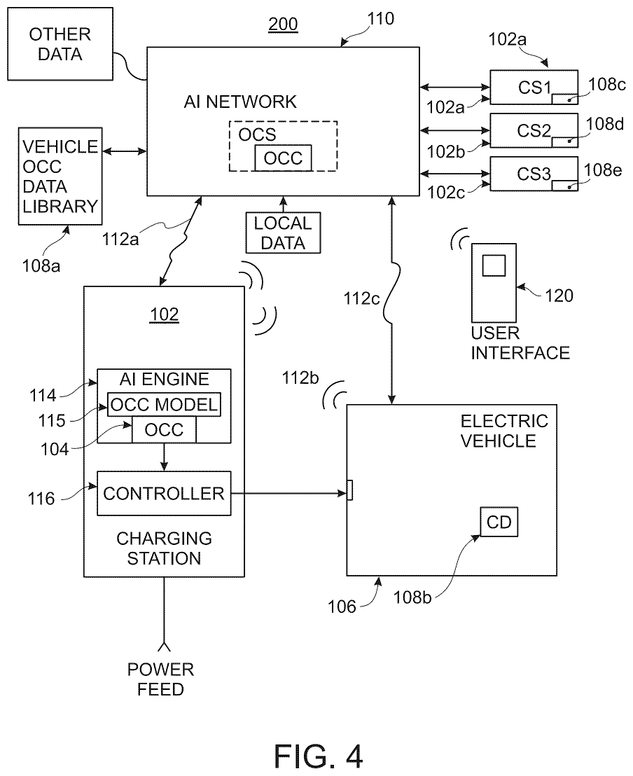

FIG. 4 is a block diagram illustrating an artificial intelligence based charging system 200, according to examples of the present disclosure. Artificial intelligence based charging system 200 is similar to charging system 100 previously detailed herein.

AI network 110 receives optimized charging configuration data specific to the vehicle requesting a charge from multiple sources and provides the optimized charging configuration data to ai engine 114. In one example, ai network 110 is in communication with multiple charging stations as part of a large charging network, illustrated as charging station 102a, charging station 102b, and charging station 102c. Charging station 102a includes optimal charging configuration data 108a stored therein from one or more previous charges either unique to the vehicle requesting a charge or the exact same vehicle model that is requesting a charge. Charging station 102b includes optimal charging configuration data 108b stored therein from one or more previous charges either unique to the vehicle requesting a charge or the exact same vehicle model that is requesting a charge. Charging station 102c includes optimal charging configuration data 108c stored therein from one or more previous charges either unique to the vehicle requesting a charge or the exact same vehicle model that is requesting a charge.

Ai engine 110 also receives optimal charging configuration data from other sources. In one example illustrated, the ai engine 110 receives optimal charging configuration data from local data sources 130. Local data sources can include, for example, weather data local to the charging station including wind, rain, and temperature data.

Vehicle optimal charging configuration data 108e is also stored on the ai engine 110. Vehicle optimal charging configuration data 108e is unique to the vehicle 106 requesting a charge and is based on vehicle charging history data. Every time vehicle 106 is charged and uses the vehicle charged battery pack for vehicle operation based on that charge, optimized data is collected. Other data sources 132 include energy data, utility data, charging station/facility capacity data, time of day data, and other relevant charging data.

The collected charging data is used to continually update the vehicle optimized charging configuration data 108e stored on the ai network 110.

User interface 120 is in communication with ai network 110 and/or charging station 102. User interface 120 allows a user to remotely configure an electric vehicle's charging configuration that is optimal to the electric vehicle and optimal to the user driving the electric vehicle. User interface 120 can communicate wired or wirelessly with ai network 110 and/or charging station 102, including ai engine 114. In examples, user interface 120 can be an application run or accessed via a mobile phone, tablet, computer, or other device suitable for communicating via a graphical user interface.

In one example, user interface 120 is used to set up parameters for a predetermined charging configuration model 115 used to determine the optimized charging configuration 104 specific to the vehicle requesting a charge. The model 115 is stored on the charging station. Alternatively, the optimal charging configuration model can be stored remotely such as on ai network 110.

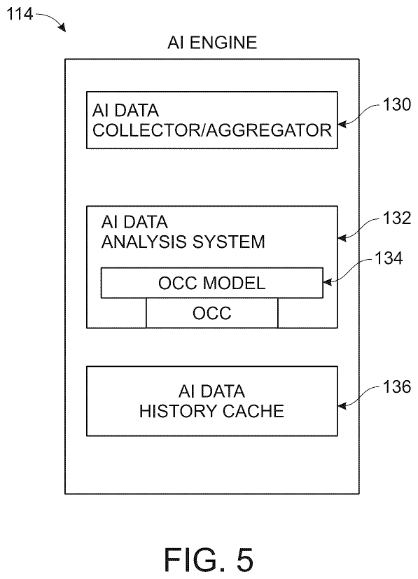

FIG. 5 is a block diagram generally illustrating one example of a charging station ai engine, indicated at 114. Ai engine 114 includes ai data collector/aggregator 130 and ai data and analysis system 132. Ai data collector 130 receives ai data (e.g., ai data components) unique to the vehicle requesting a charge and organizes (i.e., aggregates) the data into data types for the ai data analysis system 132. The optimized charging configuration is determined by ai data analysis system 132. The aggregated data is provided to the ai data analysis system 132. In one example, data analysis system 132 includes optimized charging configuration model 134 which can be similar to data model 115 detailed herein). Aggregated data is provided to the optimized charging configuration model 134. The optimized charging configuration model 134 provides an output to the charging station controller that is the optimized charging configuration 104 for the specific vehicle requesting a charge.

Ai engine 114 further can include an ai data history cache 136. The ai data history cache 136 operates to store historical charging data for specific vehicles, including optimized charging configurations for specific vehicles. For example, if the charging station is located at a home base, home garage, or home facility where the electric vehicle is regularly charged, an optimized charging configuration is stored locally in the charging station for that specific vehicle. Additionally, each time a specific vehicle is charged at that charging station the optimized charging configuration specific to the vehicle receiving a charge is updated in the ai data history cache.

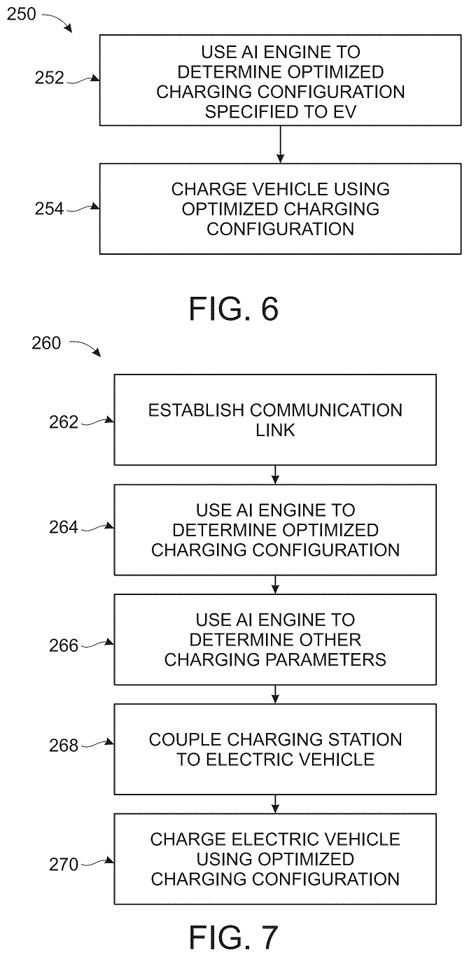

FIG. 6 is a block diagram illustrating a method for charging a vehicle, according to examples of the present disclosure. The method is illustrated generally at 250. At 252, the system includes an ai engine used to determine an optimized charging configuration for a vehicle. The optimized charging configuration is specific to the vehicle requesting a charge. At 254, the vehicle is charged using the optimized charging configuration.

FIG. 7 is a block diagram illustrating a method for charging a vehicle, according to examples of the present disclosure. The method is illustrated generally at 260. At 262, a communication link is established between the charging station and the vehicle requesting a charge. In one example, the communication link is established directly between the charging station and the ai engine, and the electric vehicle and the ai engine. In another example, the communication link is established directly between the charging station and the electric vehicle requesting a charge.

At 264, the ai engine is used to determine an optimized charging configuration specific to the vehicle requesting a charge. At 266, the ai engine is used to determine other charging parameters. For example, the charging station can use the ai engine to determine other charging parameters that includes utility data, weather data, or time of day charging data.

At 268, the charging station is electrically coupled to the electric vehicle. The charging station can be autonomously coupled to the electric vehicle or manually coupled to the electric vehicle. At 270, the electric vehicle is charged using the optimized charging configuration.

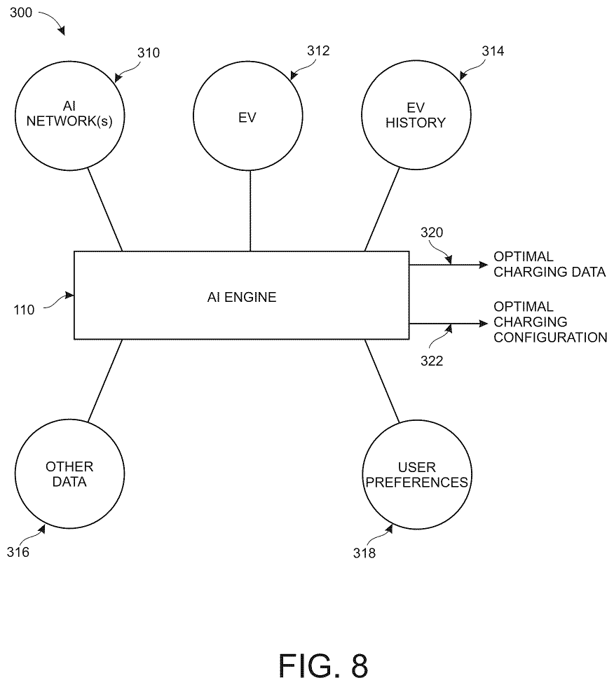

FIG. 8 is a diagram illustrating an example charging system 300, including an ai engine using artificial intelligence components for determining an electric vehicle optimal charging configuration. The ai engine 110 grabs optimal charging data from multiple data sources for aid in determining an optimized charging configuration for a vehicle requesting a charge. In one example illustrated, the ai engine 110 is in communication with one or more ai networks 310. The ai networks provide a variety of ai data components to the ai engine 110, including specific vehicle model optimized charging configuration data components, charging history from other charging stations for similar vehicles, and charging history for the same vehicle obtained from other charging stations. At 312, the ai engine obtains ai charging data components specific to the electric vehicle requesting a charge. For example, a unique identifier, number, or vehicle identification number for the vehicle requesting a charge can be queried to an external data base for obtaining manufacturer recommended data components for use in determining an optimized charging configuration for a specific vehicle.

At 314, the ai engine can obtain ai charging data components including ev history charging data components specific to the electric vehicle requesting a charge. At 316, other data components can be retrieved by the ai engine 110. The other data components 316 include weather data components, battery data components, etc. At 318, the ai engine can obtain user preferences. The user preferences can be learned through generative learning techniques over time, or can be received directly from a vehicle through an user interface application or the electric vehicle requesting a charge. In response to receiving ai charging data components from multiple data sources, outputs can be provided to the charging station. In one example, output data components 320 representative of charging data is output to the charging station. In another example, an optimized charging configuration 322 is determined by the ai engine 100 using the data component source and output to the charging station for use by the charging station in establishing charging parameters for charging the electric vehicle.

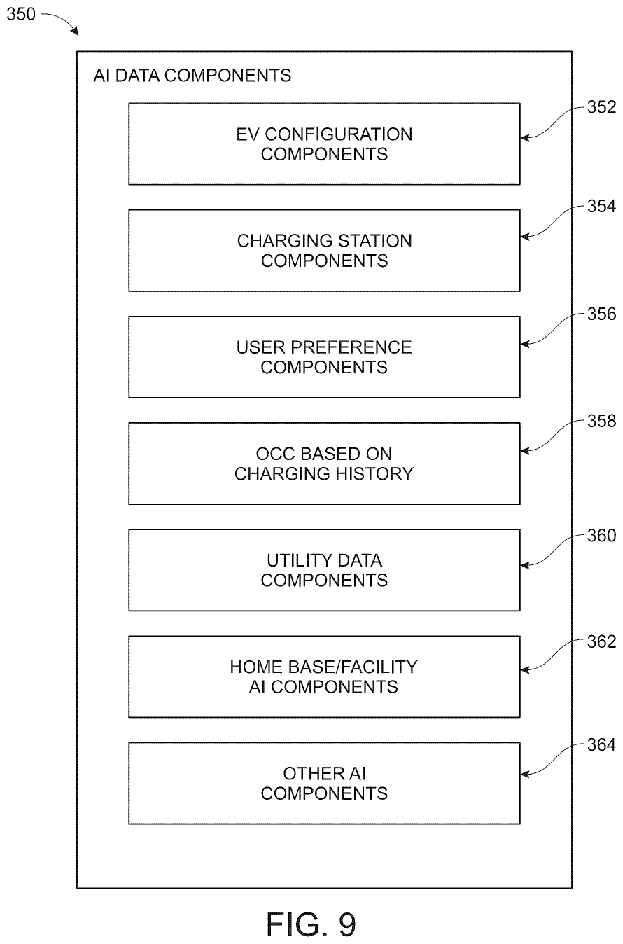

FIG. 9 is a diagram illustrating example artificial intelligence data components for use in a charging system by an ai engine or a charging station. Example data component types include electric vehicle specific configuration components 352; charging station components 354; user preference components 356; optimized charging configuration based on charging history 358; utility data components 360; home base/home facility charging data components 362; and other data components 364.

It is recognized that the charging system of the present disclosure can be configured for use in many charging system applications, including those not disclosed herein.

The ideas of the present application can be applied to home charging systems, public charging systems, and also to other facilities such as industrial or municipal facilities configured for charging electric vehicles.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle charging system and method as disclosed herein and equivalents.

2. An electric vehicle charging system comprising:
a charging system that optimizes charging of the electric vehicle using an artificial intelligence based charging system.

3. The electric vehicle charging system of claim 2, wherein the artificial intelligence based charging system includes an AI engine for determining an optimal charging configuration for an electric vehicle requesting a charge.
